(19) United States
(12) Patent Application Publication
(10) Pub. No.: US 2023/0206667 A1
(43) Pub. Date: Jun. 29, 2023

(54) METHOD FOR RECOGNIZING TEXT, DEVICE, AND STORAGE MEDIUM

(71) Applicant: BEIJING BAIDU NETCOM SCIENCE TECHNOLOGY CO., LTD., Beijing (CN)

(72) Inventors: Pengyuan LV, Beijing (CN); Liang WU, Beijing (CN); Shanshan LIU, Beijing (CN); Meina QIAO, Beijing (CN); Chengquan ZHANG, Beijing (CN); Kun YAO, Beijing (CN); Junyu HAN, Beijing (CN)

(21) Appl. No.: 18/147,806

(22) Filed: Dec. 29, 2022

(30) Foreign Application Priority Data
Jan. 6, 2022 (CN) 202210013633.0

(51) Int. Cl. G06V 30/19; G06V 30/16

(52) U.S. Cl. CPC G06V 30/19127; G06V 30/16

(57) ABSTRACT

A method for recognizing text includes: obtaining a first feature map of an image; for each target feature unit, performing a feature enhancement process on a plurality of feature values of the target feature unit respectively based on the plurality of feature values of the target feature unit, in which the target feature unit is a feature unit in the first feature map along a feature enhancement direction; and performing a text recognition process on the image based on the first feature map after the feature enhancement process.

### CROSS-REFERENCE TO RELATED APPLICATION

This application claims priority to Chinese Patent Application No. 202210013633.0, filed on Jan. 6, 2022, the entire disclosure of which is incorporated herein by reference.

### TECHNICAL FIELD

The disclosure relates to the field of Artificial Intelligence (AI) technologies, especially the field of deep learning and computer vision technologies, and can be applied to scenarios such as optical character recognition (OCR).

### BACKGROUND

There may be text in images involved in many fields such as education, healthcare, and finance. To accurately process information based on the image, it is necessary to obtain a text recognition result by performing a text recognition process on the image and process information based on the text recognition result.

### SUMMARY

According to a first aspect of the disclosure, a method for recognizing text is provided. The method includes: obtaining a first feature map of an image; for each target feature unit, based on a plurality of feature values of the target feature unit, performing a feature enhancement process on a plurality of feature values of the target feature unit respectively, in which the target feature unit is a feature unit in the first feature map along a feature enhancement direction; and performing a text recognition process on the image based on the first feature map after the feature enhancement process.

According to a second aspect of the disclosure, an electronic device is provided. The electronic device includes: at least one processor and a memory communicatively coupled to the at least one processor. The memory stores instructions executable by the at least one processor, and when the instructions are executed by the at least one processor, the at least one processor is caused to implement the method for recognizing text.

According to a third aspect of the disclosure, a non-transitory computer-readable storage medium having computer instructions stored thereon is provided. The computer instructions are configured to cause a computer to implement the method for recognizing text.

The content described in this section is not intended to identify key or important features of embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solutions and do not constitute a limitation to the disclosure, in which:

FIG. 1a is a flowchart of a first method for recognizing text according to some embodiments of the disclosure.

FIG. 1b is a schematic diagram of an image of a first type of curved text according to some embodiments of the disclosure.

FIG. 1c is a schematic diagram of an image of a second type of curved text according to some embodiments of the disclosure.

FIG. 2a is a flowchart of a second method for recognizing text according to some embodiments of the disclosure.

FIG. 2b is a flowchart of a feature enhancement process according to some embodiments of the disclosure.

FIG. 3 is a flowchart of a third method for recognizing text according to some embodiments of the disclosure.

FIG. 4 is a flowchart of a fourth method for recognizing text according to some embodiments of the disclosure.

FIG. 5 is a flowchart of a fifth method for recognizing text according to some embodiments of the disclosure.

FIG. 6 is a schematic diagram of a first apparatus for recognizing text according to some embodiments of the disclosure.

FIG. 7 is a schematic diagram of a second apparatus for recognizing text according to some embodiments of the disclosure.

FIG. 8 is a schematic diagram of a third apparatus for recognizing text according to some embodiments of the disclosure.

FIG. 9 is a block diagram of an electronic device for implementing a method for recognizing text according to some embodiments of the disclosure.

### DETAILED DESCRIPTION

The following describes some embodiments of the disclosure with reference to the accompanying drawings, which includes various details of embodiments of the disclosure to facilitate understanding and shall be considered merely exemplary. Therefore, those skilled in the art should recognize that various changes and modifications can be made to embodiments described herein without departing from the scope and spirit of the disclosure. For clarity and conciseness, descriptions of well-known functions and structures are omitted in the following description.

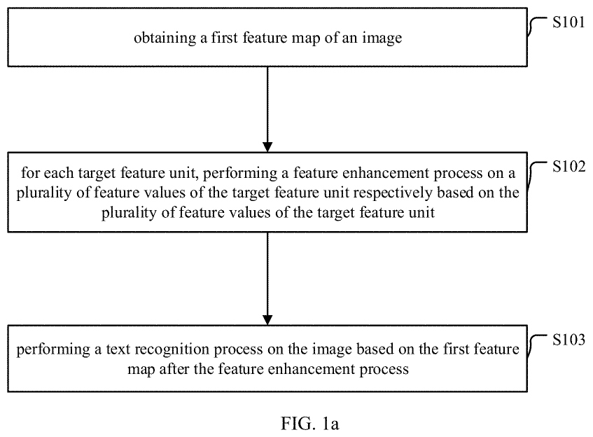

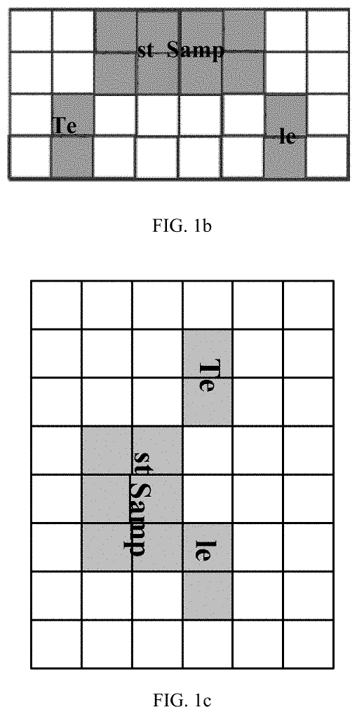

As shown in FIG. 1a, FIG. 1a is a flowchart of a first method for recognizing text according to some embodiments of the disclosure. The method includes the following steps S101 to S103.

At step S101, a first feature map of an image is obtained.

The above image is an image containing text. The text contained in the image may be curved text or un-curved text. The above text in the curved text is arranged in a curve pattern.

For example, FIG. 1b is a schematic diagram of an image of a first type of curved text. The text in the image in FIG. 1b is arranged in a curve pattern along a pixel row direction, i.e., all the text is not located in the same pixel row.

For example, FIG. 1c is a schematic diagram of an image of a second type of curved text. The text in the image in FIG. 1c is arranged in a curve pattern along a pixel column direction, i.e., all the text is not located in the same pixel column.

The first feature map described above may be a map that contains feature values of the image in many dimensions. The dimensions of the first feature map depend on the specific scene.

For example, the first feature map may be a two-dimensional feature map, in which case the two dimensions may be a width dimension and a height dimension.

For example, the first feature map may be a three-dimensional feature map, in which case the three dimensions may be a width dimension, a height dimension, and a depth dimension. The size of the depth dimension may be determined by a number of channels of the image. For example, assuming that the image is in a Red, Green, and Blue (RGB) format, the image has three channels, namely R channel, G channel, and B channel, and the size of the depth dimension is 3, and values of the image in the depth dimension are 1, 2, and 3. In this case, it is considered that the first feature map includes three two-dimensional feature maps, and each two-dimensional feature map corresponds to two dimensions, i.e., the width dimension and height dimension.

In conclusion, the first feature map can be a two-dimensional feature map or a multi-dimensional feature map containing a plurality of two-dimensional feature maps.

In detail, the first feature map can be obtained in two different implementations.

In the first implementation, the image can be obtained firstly, and feature extraction can be performed on the image to obtain the first feature map described above.

In the second implementation, the feature extraction can be performed on the image firstly by other device with feature extraction capabilities, and then the feature map obtained from the feature extraction of the image by this device is determined as the first feature map.

The feature extraction of the image may be implemented based on a feature extraction network model or a feature extraction algorithm in the related art. For example, the above feature extraction network model may be a convolutional neural network model, such as, a vgg network model, a renset network model, and a mobilenet network model. The above feature extraction model may also be a network model, such as, Feature Pyramid Networks (FPN), and Pixel Aggregation Network (PAN). The above feature extraction algorithm can be operators, such as, deformconv, se, dilationconv, and inception.

At step S102, for each target feature unit, a feature enhancement process is performed on a plurality of feature values of the target feature unit respectively based on the plurality of feature values of the target feature unit.

The image feature of the image has a receptive field, and the receptive field can be understood as an image feature source. The receptive field can be a part of the image for which the image feature is representative. Different image features may have different receptive fields, and when the receptive field of the image feature changes, the image feature also changes. The above feature enhancement process is performed on each feature value of the target feature unit in the first feature map, which can expand the receptive field of the feature value in the first feature map, thereby improving the representativeness of the first feature map for the image.

The target feature unit is a feature unit in the first feature map along a feature enhancement direction.

The above feature unit is one-dimensional feature data, and the number of feature values contained in the one-dimensional feature data is identical to the size of the dimension corresponding to the feature enhancement direction in the first feature map.

The feature enhancement direction can be the pixel row direction of the first feature map, and the dimension corresponding to the direction is the width dimension. The feature enhancement direction can be the pixel column direction of the first feature map, and the dimension corresponding to the direction is the height dimension.

In particular, the feature enhancement direction can be determined in different ways.

In an implementation, the feature enhancement direction can be preset artificially.

In another implementation, a direction different from the detected alignment direction may be determined as the feature enhancement direction by detecting the alignment direction of the text in the image.

For example, if the text in the image is arranged in the pixel row direction, a direction different from the pixel row direction, i.e., the pixel column direction, may be determined as the feature enhancement direction.

Different feature enhancement directions have different target feature units, and the details are described in the following embodiments and will not be detailed herein.

At this step, when the feature enhancement is performed each feature value of the target feature unit, each feature value in the target feature unit is considered.

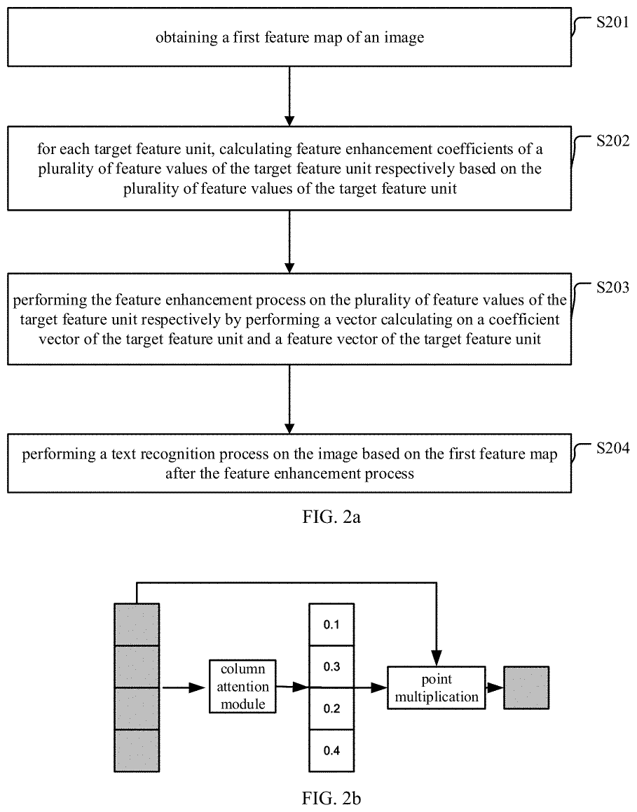

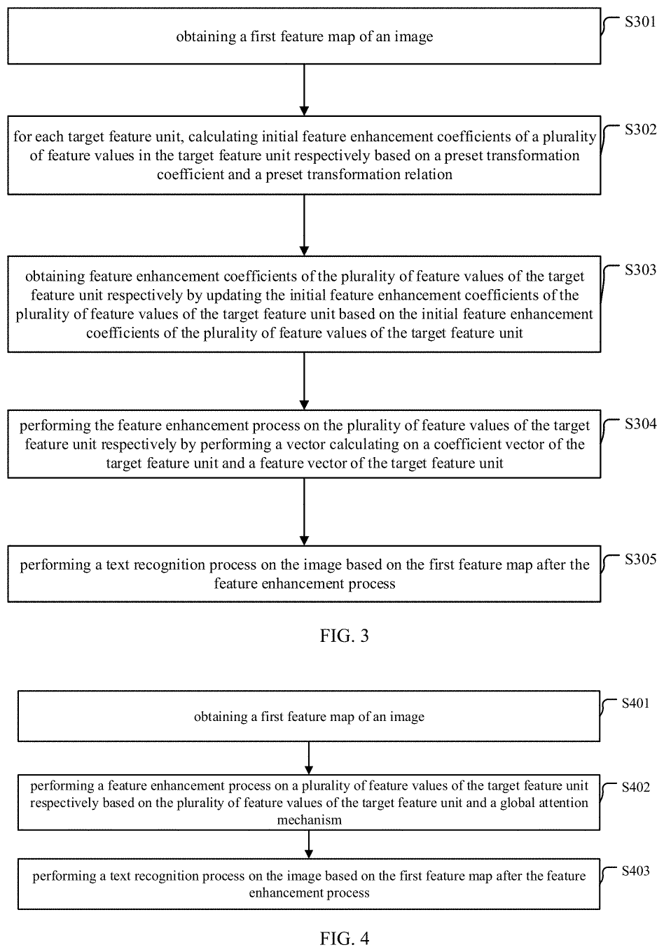

The specific implementation of the feature enhancement process for each feature value in the target feature unit can be found in the descriptions of steps S202-S204 in some embodiments in FIG. 2a and step S402 in some embodiments in FIG. 4, and will not be described in detail herein.

At step S103, a text recognition process is performed on the image based on the first feature map after the feature enhancement process.

In an implementation, after the first feature map is received after the feature enhancement process, a text box in the image can be predicted based on the feature map, and then the text recognition process can be performed on the content in the text box, to obtain the text contained in the image.

In detail, the text recognition can be achieved by various existing decoding techniques, which will not be described in detail herein.

Further, in the existing text recognition schemes, the text recognition is generally performed based on the features of the image, and in the text recognition solutions provided by some embodiments of the disclosure, more representative image features can be obtained through the feature enhancement process. Therefore, the text recognition solutions of the disclosure are introduced with the above-mentioned feature enhancement process based on the existing text recognition solutions, so that the text recognition accuracy can be improved.

In conclusion, when the solutions in embodiments of the disclosure are applied to recognize text, after the first feature map of the image is obtained, for each target feature unit, the feature enhancement process is performed on each feature value of the target feature unit respectively based on the plurality of feature values of the target feature unit, and the text recognition process is performed on the image based on the first feature map after the feature enhancement process, thereby realizing the text recognition of the image.

In addition, since the object of the feature enhancement process in some embodiments of the disclosure is each of the feature values of the target feature unit rather than the full first feature map, the feature enhancement process only needs to consider features in the feature enhancement direction and does not need to consider relative locations of characters contained in the text of the image, so that the solutions of the disclosure can accurately recognize both the regularly-arranged text and the curved text in the image, thereby expanding the range of applications for text recognition.

The target feature unit is described below for two feature enhancement directions.

In the first case, the feature enhancement direction is the pixel column direction of the first feature map, and the target feature unit is a column feature unit of the first feature map.

The column feature unit includes the feature values on a pixel column of the first feature map. It is known from the previous description that the first feature map may be a multidimensional feature map including a plurality of two-dimensional feature maps, in which the column feature unit corresponds to a pixel column in a two-dimensional feature map in the first feature map, and the column feature unit includes the feature values on that pixel column in the two-dimensional feature map.

In the image in FIG. 1b, the text is curved in the pixel row direction, and the features of the image are more representative in the pixel column direction. In the above case, when the feature enhancement process is performed on the first feature map, that is, the feature enhancement process is performed on each column feature unit respectively, the feature values of the first feature map in the pixel column direction can be enhanced. Therefore, after the feature enhancement process is performed on the first feature map according to the above case, it is possible to improve the accuracy of the text recognition when the text recognition process is performed on the image with curved text in the pixel row direction in FIG. 1b.

In the second case, the feature enhancement direction is the pixel row direction of the first feature map, and the target feature unit is a row feature unit of the first feature map.

Similar to the above column feature unit, the row feature unit includes feature values on a pixel row in the first feature map. It is known from the previous description that the first feature map can be a multidimensional feature map including a plurality of two-dimensional feature maps. In this case, the row feature unit corresponds to a pixel row in a two-dimensional feature map in the first feature map, and the row feature unit includes the feature values on the pixel row in the two-dimensional feature map.

In the image in FIG. 1c, the text is curved in the pixel column direction, and the features of the image in the pixel row direction are more representative. In the above case, when the feature enhancement process is performed on the first feature map, the feature enhancement process is performed on each row feature unit respectively, so that the features in the pixel row direction in the first feature map can be enhanced. Therefore, after the feature enhancement process is performed on the first feature map according to the above case, the accuracy of the text recognition can be improved when the text recognition is performed on an image similar to the image with the curved text in the pixel column direction in FIG. 1c.

According to FIG. 2a, the specific implementation of the feature enhancement process for each feature value in the target feature unit at step S102 will be described below.

In some embodiments of the disclosure, FIG. 2a is a flowchart of a second method for recognizing text. In some embodiments, the above method includes the following steps S201-S204.

At step S201, a first feature map of an image is obtained.

The above step S201 is the same as the previous step S101, and will not be repeated herein.

At step S202, for each target feature unit, feature enhancement coefficients of a plurality of feature values of the target feature unit are calculated respectively based on the plurality of feature values of the target feature unit.

In one case, the feature enhancement coefficient of the feature value can be understood as a representative strength of the feature value on the image. The larger the coefficient, the stronger the representative strength. The smaller the coefficient, the weaker the representative strength.

For each feature value in the target feature unit, there may be implementations for calculating the feature enhancement coefficient of the feature value.

In the first implementation, the feature enhancement coefficient can be calculated through steps S302 to S303 in some embodiments in FIG. 3, which will not be described in detail herein.

In the second implementation, each feature value of the target feature unit can be used to calculate a weight coefficient of the feature value, and the weight coefficient can be used as the feature enhancement coefficient of the feature value. The weight coefficient of the feature value indicates a ratio of the feature value to the target feature unit.

For example, since the larger the feature value, the stronger the representative strength, a ratio of the feature value to a sum of all feature values in the target feature unit can be calculated. The larger the ratio, the greater the weight coefficient, and the smaller the ratio, the smaller the weight coefficient. In addition, the weight coefficient of the feature value can also be calculated in other ways, which is not limited in embodiments of the disclosure.

In the third implementation, if the feature enhancement direction is the pixel column direction, an attention coefficient of each feature value in the target feature unit may be calculated based on a column attention mechanism as the feature enhancement coefficient of the feature value.

If the feature enhancement direction is the pixel row direction, an attention coefficient of each feature value in the target feature unit can be calculated based on a row attention mechanism as the feature enhancement coefficient of the feature value.

In addition to the above three implementations, it is also possible to enable the calculation process on the feature enhancement coefficient of each feature value in the target feature unit by other means, which are not described in detail herein.

At step S203, the feature enhancement process is performed on the plurality of feature values of the target feature unit respectively by performing a vector calculating on a coefficient vector of the target feature unit and a feature vector of the target feature unit.

The coefficient vector is a vector composed of weight coefficients of the feature values of the target feature unit along the feature enhancement direction, and the feature vector is a vector composed of the feature values of the target feature unit along the feature enhancement direction.

In detail, for the target feature unit, the coefficient vector and the feature vector of the target feature unit can be obtained firstly, and then the vector calculating is performed on the coefficient vector and the feature vector to obtain an operation result of the target feature unit. Since both the coefficient vector and the feature vector are vectors along the feature enhancement direction, these two vectors may be one-dimensional row vectors or one-dimensional column vectors. On the basis, in one case, the above vector calculating may be a linear weighting operation on the elements in the vector, in this case, the obtained operation result includes one element.

Through the above process on the target feature unit, one operation result can be obtained. After the above process is performed on all the target feature units, the same number of operation results as the number of the target feature units can be obtained, and the obtained operation results can constitute feature data, and the feature data can be determined as the first feature map after the feature enhancement process.

If the above-described first feature map is a two-dimensional feature map, the feature data is one-dimensional feature data, a dimension of the one-dimensional feature data corresponds to another dimension other than a dimension corresponding to the feature enhancement direction in the first feature map, and a size of the one-dimensional feature data is the same as the size of another dimension of the first feature map.

If the above-mentioned first feature map is a three-dimensional feature map, the above feature data is two-dimensional feature data, and the two-dimensional feature data may have two dimensions which correspond to two dimensions other than the dimension corresponding to the feature enhancement direction in the above first feature map, and for each of the two dimensions, the size of the dimension in the two-dimensional feature data is the same as the size of the corresponding dimension of the first feature map.

After the above feature vector of the target feature unit is obtained, the feature values of the target feature unit can be determined sequentially along the feature enhancement direction, and each feature value can be used as an element at a corresponding location in the vector according to the order in which the feature values are determined, so as to obtain the feature vector.

For example, the target feature unit includes three feature values along the feature enhancement direction, namely, p1, p2, and p3. It can be determined that the first feature value in the target feature unit is p1, the second feature value is p2, and the third feature value is p3, then p1 can be used as an element at the first location in the vector, p2 as an element at the second location in the vector, and p3 as an element at the third location in the vector, to obtain the feature vector composed of p1, p2, and p3.

The coefficient vector described above is obtained in a manner like the way the above feature vector is obtained. The feature enhancement coefficients of the feature values of the target feature unit can be determined sequentially, and each of the feature enhancement coefficients is used as an element at a corresponding location in the vector according to the order in which the feature enhancement coefficients are determined, to obtain the coefficient vector.

In some embodiments of the disclosure, after the feature vector and the coefficient vector are obtained, a point multiplication can be performed on the feature vector and the coefficient vector, to obtain a point multiplication result.

For example, FIG. 2b is a flowchart of a feature enhancement process. In FIG. 2b, the four small squares on the leftmost side stacked in a column represent the target feature unit including four feature values, and each small square corresponds to a feature value. A column attention module is a module created based on the column attention mechanism, which is used to calculate the feature enhancement coefficients of the feature values of the target feature unit. After the above target feature unit is input to the column attention module, the feature enhancement coefficients of these four feature values of the target feature unit are obtained, and then the point multiplication is performed on the feature vector composed of the four feature values of the target feature unit and the coefficient vector composed of the feature enhancement coefficients of these four feature values, to obtain the operation result, i.e., the rightmost small square. The result includes one feature value obtained after the point multiplication.

At step S204, a text recognition process is performed on the image based on the first feature map after the feature enhancement process.

The above step S204 is the same as the preceding step S103 and will not be repeated herein.

As can be seen from the above, according to the method for recognizing text of the disclosure, since the feature enhancement coefficients of the feature values of the target feature unit are calculated based on the feature values of the target feature unit, so that the overall information of the target feature unit is considered when calculating the feature enhancement coefficients of the feature values. Therefore, after the vector calculating is performed on the feature vector and the coefficient vector of the target feature unit, the feature values of the target feature unit can be enhanced based on the overall information of that target feature unit, that is, the feature values of the first feature map are enhanced in the feature enhancement direction, so that the text recognition is performed on the image based on the first feature map after the enhancement process, thereby improving the accuracy of the text recognition.

To calculate the feature enhancement coefficients of the feature values of the target feature unit, in addition to the manner provided at step S202 above, the feature enhancement process can be implemented by steps S302 to S303 in some embodiments in FIG. 3.

In some embodiments of the disclosure, FIG. 3 is a flowchart of a third method for recognizing text. In some embodiments, the above method includes the following steps S301-S305.

At step S301, a first feature map of an image is obtained.

The above step S301 is the same as the previous step S101, and will not be repeated herein.

At step S302, for each target feature unit, initial feature enhancement coefficients of a plurality of feature values in the target feature unit are calculated respectively based on a preset transformation coefficient and a preset transformation relation.

The above transformation coefficient can be preset manually. In addition, since the text recognition can be realized through a text recognition network model, the above transformation coefficient can also be calculated according to model parameters of the trained text recognition network model.

The above transformation relation can be a relation artificially specified between the feature value and the initial feature enhancement coefficient of the feature value.

In some embodiments of the disclosure, the initial feature enhancement coefficients of the plurality of feature values in the target feature unit can be calculated respectively according to the following expression:

e=W₁^{T} tan h(W₂h+b)

where e represents the initial feature enhancement coefficient, h represents the feature value, W₁ represents a first transformation parameter, W₁^{T} represents a transposition matrix of the first transformation parameter, W₂ represents a second transformation parameter, and b represents a third transformation parameter.

In this way, the initial feature enhancement coefficients of the feature values can be calculated accurately and conveniently through the above expression.

Certainly, the initial feature enhancement coefficients of the feature values of the target feature unit can also be calculated in other ways, which will not be listed here.

At step S303, feature enhancement coefficients of the plurality of feature values of the target feature unit are obtained respectively by updating the initial feature enhancement coefficients of the plurality of feature values of the target feature unit based on the initial feature enhancement coefficients of the plurality of feature values of the target feature unit.

In detail, the target feature unit may include multiple feature values. For each feature value, the initial feature enhancement coefficient of the feature value can be calculated, and when updating the initial feature enhancement coefficient of the feature value, the initial feature enhancement coefficient of the feature value can be updated based on the initial feature enhancement coefficient of the feature value of the target feature unit, to obtain the feature enhancement coefficient of the feature value.

In some embodiments of the disclosure, the feature enhancement coefficients of the plurality of feature values in the target feature unit can be calculated respectively according to the following expression:

$${α}_{j} = exp ( {e}_{j} ) / {\sum }_{j = 1}^{j = n} exp ( {e}_{j} )$$

where eⱼ represents the initial feature enhancement coefficient of the j^{th} feature value in the target feature unit, αⱼ represents the feature enhancement coefficient of the j^{th} feature value in the target feature unit, and n represents a number of the plurality of feature values in the target feature unit. In this way, the initial feature enhancement coefficients of the feature values of the target feature unit are updated according to the above expression, and the initial feature enhancement coefficients of the feature values of the target feature unit can be accurately obtained.

Certainly, the feature enhancement coefficients of the feature values can also be updated in other ways, which are not limited here.

At step S304, a feature enhancement process is performed on the plurality of feature values of the target feature unit respectively by performing a vector calculating on a coefficient vector of the target feature unit and a feature vector of the target feature unit.

The coefficient vector is a vector composed of weight coefficients of the feature values of the target feature unit along the feature enhancement direction, and the feature vector is a vector composed of the feature values of the target feature unit along the feature enhancement direction.

At step S305, a text recognition process is performed on the image based on the first feature map after the feature enhancement process.

The above step S304 is the same as the preceding step S203, and the above step S305 is the same as the preceding step S103, which are not repeated herein.

As seen above, according to the solution for recognizing text of the disclosure, the initial feature enhancement coefficients of the feature values of the target feature unit can be accurately calculated at first based on the preset transformation coefficient and the preset transformation relation, and then the initial feature enhancement coefficients of the feature values of the target feature unit can be updated based on the initial feature enhancement coefficients of the feature values of the target feature unit. In this way, the feature enhancement coefficients of the feature values can be accurately obtained, the feature enhancement process can be performed on the first feature map based on the more accurate feature enhancement coefficients, and the text in the image can be recognized based on the first feature map after the feature enhancement process, which can improve the accuracy of the text recognition.

To perform the feature enhancement process on the feature values of the target feature unit, in addition to the manner referred to at steps S202-S203 in some embodiments in FIG. 2a above, the feature enhancement process may be achieved using step S402 in some embodiments in FIG. 4 below.

In some embodiments of the disclosure, FIG. 4 is a flowchart of a fourth method for recognizing text. In some embodiments, the above method includes the following steps S401-S403.

At step S401, a first feature map of an image is obtained.

The above step S401 is the same as the preceding step S101 and is not repeated herein.

At step S402, a feature enhancement process is performed on a plurality of feature values of the target feature unit respectively based on the plurality of feature values of the target feature unit and a global attention mechanism.

In some embodiments, the global attention mechanism described above is a mechanism that focuses on key feature values while considering all the feature values in the target feature unit. In detail, the object of each feature enhancement process performed based on the global attention mechanism is the target feature unit, and the entire data considered by the global attention mechanism is all the feature values in the target feature unit.

The key feature values can be understood as the feature values that are more representative of the image.

If the target feature unit is a column feature unit, the global attention mechanism used may be viewed as a column attention mechanism. If the target feature unit is a row feature unit, the global attention mechanism used may be viewed as a row attention mechanism.

The feature enhancement process on the feature values of the target feature unit based on the global attention mechanism can be implemented by the existing global attention mechanism implementations, which will not be described in detail herein.

At step S403, a text recognition process is performed on the image based on the first feature map after the feature enhancement process.

The above step S403 is the same as the preceding step S103 and is not repeated herein.

As seen above, according to the solution for recognizing text of the disclosure, the object of the global attention mechanism is the target feature unit, and the mechanism focuses on the key feature values of the target feature unit while considering all the feature values of the target feature unit, so that the feature enhancement process can focuses more on the feature values that are more representative of the image. Since the more representative feature values generally have a greater impact on the feature enhancement process, the feature enhancement process is performed on each feature value of the target feature unit using the global attention mechanism, which can improve the accuracy of the feature enhancement process, so that the representativeness of the first feature map after the feature enhancement process can be enhanced, and the text recognition performed on the image based on the more representative feature values can improve the accuracy of the text recognition.

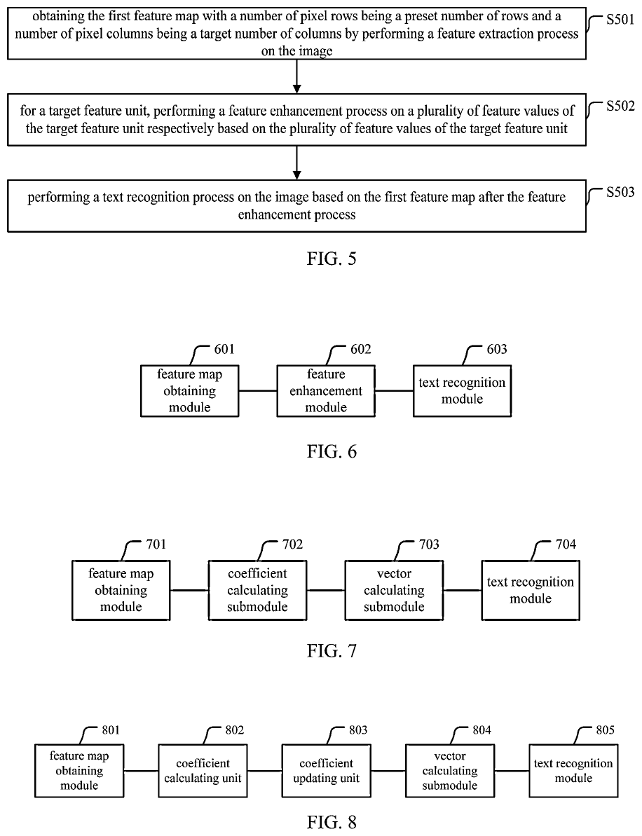

In order to obtain the first feature map of the image, the image can be obtained first, and then the feature extraction is performed on the image to obtain the image features of the image as the first feature map. In detail, the first feature map of the image can be obtained at step S501 in some embodiments in FIG. 5 below.

In some embodiments of the disclosure, FIG. 5 is a flowchart of a fifth method for recognizing text. In this embodiment, the above method includes the following steps S501-S503.

At step S501, a first feature map with a number of pixel rows being a preset number of rows and a number of pixel columns being a target number of columns is obtained by performing a feature extraction process on an image.

The preset number of rows is greater than 1, for example, 4, 5, or other preset number. Since the above preset number of rows is greater than 1, each pixel column of the first feature map includes a plurality of pixel points, i.e., a plurality of feature values. The plurality of feature values can be used to represent the feature of the pixel row direction of the image based on the feature values corresponding to each pixel column in the first feature map, so that the data used to represent the feature can be richer and representative.

The target number of columns is calculated based on the number of pixel columns of the image and the preset number of rows.

For example, the number of pixel columns of the image can be divided by the preset number of rows, and the division result is obtained as the above target number of columns.

In detail, the feature extraction can be performed on the image to obtain the first feature map with the preset number of rows and the target number of columns by the following three implementations.

In the first implementation, the features of the image can be extracted by the feature extraction network model, which is required to be trained in advance. In the training phase of the feature extraction network model, the feature extraction network model is trained using the sample image and a sample feature map of the sample image. The number of pixel rows of the sample feature map is the preset number of rows as described above, and the number of pixel columns of the sample feature map is the number of columns calculated based on the number of pixel columns of the sample image and the preset number of rows, so that after the trained feature extraction network model is obtained, the feature extraction network model can learn a transformation law between the image size and the feature map size. Based on the above, after inputting the image into the feature extraction network model, the first feature map with the preset number of rows and the target number of columns can be output.

In the second implementation, after the above image is obtained, it is possible to calculate the above target number of columns based on the number of pixel columns of the image and the preset number of rows, so that the size of the first feature map is determined based on the target number of columns and the preset number of rows, and then a target size of the image to be subjected to the feature extraction is determined based on the size of the first feature map, and the size of the image is transformed to the target size, so that the feature extraction is performed on the image after the size transformation, and the first feature map with the preset number of rows and the target number of columns can be obtained.

In one case, the above target size can be determined based on the correspondence between the size of the feature map and the size of the image on which the image feature extraction is performed, and the size of the first feature map.

In the third implementation, after the above image is obtained, the target size of the first feature map can be determined by calculating the above target number of columns based on the number of pixel columns of the image and the preset number of rows, and then, after the feature extraction is performed on the image, if the size of the obtained feature map is inconsistent with the above target size, the size transformation is performed on the above feature map to obtain the feature map of the target size, i.e., the first feature map.

At step S502, a feature enhancement process is performed on a plurality of feature values of the target feature unit respectively based on the plurality of feature values of the target feature unit, in which the target feature unit is a feature unit in the first feature map along a feature enhancement direction.

At step S503, a text recognition process is performed on the image based on the first feature map after the feature enhancement process.

The above steps S502-S503 are the same as the steps S102-S103 respectively, and are not repeated herein.

As can be seen from the above, according to the method for recognizing text of embodiments of the disclosure, the first feature maps obtained after the feature extraction is performed on the images of different sizes are under the same criterion, so that in the case where the above feature enhancement direction is the pixel column direction, the target feature units corresponding to different images all include the same number of feature values, which can improve the uniformity of the feature enhancement process for each feature value of the target feature unit, and improve the efficiency of the text recognition.

In addition, the solution of the embodiment also sets the number of pixel columns of the first feature map described above to the preset number of columns, and sets the number of pixel rows to a number of rows calculated based on the number of pixel rows of the image and the preset number of columns, so that the uniformity of the feature enhancement process for each feature value in the target feature unit can also be improved in the case where the feature enhancement direction described above is the pixel row direction.

Corresponding to the above method for recognizing text, some embodiments of the disclosure also provide an apparatus for recognizing text.

As shown in FIG. 6, FIG. 6 is a schematic diagram of a first apparatus for recognizing text according to some embodiments of the disclosure. The apparatus includes: a feature map obtaining module 601, a feature enhancement module 602 and a text recognition module 603.

The feature map obtaining module 601 is configured to obtain a first feature map of an image.

The feature enhancement module 602 is configured to, for each target feature unit, perform a feature enhancement process on a plurality of feature values of the target feature unit respectively based on the plurality of feature values of the target feature unit, in which the target feature unit is a feature unit in the first feature map along a feature enhancement direction.

The text recognition module 603 is configured to perform a text recognition process on the image based on the first feature map after the feature enhancement process.

In conclusion, when the solutions in embodiments of the disclosure are applied to recognize text, after the first feature map of the image is obtained, for each target feature unit, the feature enhancement process is performed on each feature value of the target feature unit respectively based on the plurality of feature values of the target feature unit, and the text recognition process is performed on the image based on the first feature map after the feature enhancement process, thereby realizing the text recognition of the image.

In addition, since the object of the feature enhancement process in some embodiments of the disclosure is each of the feature values of the target feature unit rather than the full first feature map, the feature enhancement process only needs to consider features in the feature enhancement direction and does not need to consider relative locations of characters contained in the text of the image, so that the solutions of the disclosure can accurately recognize both the regularly-arranged text and the curved text in the image, thereby expanding the range of applications for text recognition.

In some embodiments of the disclosure, FIG. 7 is a schematic diagram of a second apparatus for recognizing text according to some embodiments of the disclosure. The apparatus includes: a feature map obtaining module 701, a coefficient calculating submodule 702, a vector calculating submodule 703 and a text recognition module 704.

The feature map obtaining module 701 is configured to obtain a first feature map of an image.

The coefficient calculating submodule 702 is configured to calculate feature enhancement coefficients of the plurality of feature values of the target feature unit respectively based on the plurality of feature values of the target feature unit.

The vector calculating submodule 703 is configured to perform the feature enhancement process on the plurality of feature values of the target feature unit respectively by performing a vector calculating on a coefficient vector of the target feature unit and a feature vector of the target feature unit, in which the coefficient vector is a vector including weight coefficients of the plurality of feature values of the target feature unit along the feature enhancement direction, and the feature vector is a vector including the plurality of feature values of the target feature unit along the feature enhancement direction.

The text recognition module 740 is configured to perform a text recognition process on the image based on the first feature map after the feature enhancement process.

As can be seen from the above, according to the apparatus for recognizing text of the disclosure, since the feature enhancement coefficients of the feature values of the target feature unit are calculated based on the feature values of the target feature unit, so that the overall information of the target feature unit is considered when calculating the feature enhancement coefficients of the feature values. Therefore, after the vector calculating is performed on the feature vector and the coefficient vector of the target feature unit, the feature values of the target feature unit can be enhanced based on the overall information of that target feature unit, that is, the feature values of the first feature map are enhanced in the feature enhancement direction, so that the text recognition is performed on the image based on the first feature map after the enhancement process, thereby improving the accuracy of the text recognition.

In some embodiments of the disclosure, FIG. 8 is a schematic diagram of a third apparatus for recognizing text. The apparatus includes: a feature map obtaining module 801, a coefficient calculating unit 802, a coefficient updating unit 803, a vector calculating submodule 804, and a text recognition module 805.

The feature map obtaining module 801 is configured to obtain a first feature map of an image.

The coefficient calculating unit 802 is configured to calculate initial feature enhancement coefficients of the plurality of feature values in the target feature unit respectively based on a preset transformation coefficient and a preset transformation relation.

The coefficient updating unit 803 is configured to obtain feature enhancement coefficients of the plurality of feature values of the target feature unit respectively by updating the initial feature enhancement coefficients of the plurality of feature values of the target feature unit based on the initial feature enhancement coefficients of the plurality of feature values of the target feature unit.

The vector calculating submodule 804 is configured to perform the feature enhancement process on the plurality of feature values of the target feature unit respectively by performing a vector calculating on a coefficient vector of the target feature unit and a feature vector of the target feature unit, in which the coefficient vector is a vector including weight coefficients of the plurality of feature values in the target feature unit along the feature enhancement direction, and the feature vector is a vector including the plurality of feature values in the target feature unit along the feature enhancement direction.

The text recognition module 805 is configured to perform a text recognition process on the image based on the first feature map after the feature enhancement process.

As seen above, according to the solution for recognizing text of the disclosure, the initial feature enhancement coefficients of the feature values of the target feature unit can be accurately calculated at first based on the preset transformation coefficient and the preset transformation relation, and then the initial feature enhancement coefficients of the feature values of the target feature unit can be updated based on the initial feature enhancement coefficients of the feature values of the target feature unit. In this way, the feature enhancement coefficients of the feature values can be accurately obtained, the feature enhancement process can be performed on the first feature map based on the more accurate feature enhancement coefficients, and the text in the image can be recognized based on the first feature map after the feature enhancement process, which can improve the accuracy of the text recognition.

In some embodiments of the disclosure, the coefficient calculating unit 802 is configured to calculate the initial feature enhancement coefficients of the plurality of feature values in the target feature unit respectively according to the following expression:

e=W₁^{T} tan h(W₂h+b)

where e represents the initial feature enhancement coefficient, h represents the feature value, W₁ represents a first transformation parameter, W₁^{T} represents a transposition matrix of the first transformation parameter, W₂ represents a second transformation parameter, and b represents a third transformation parameter.

e=W₁^{T} tan h(W₂h+b)

As seen above, according to the solution for recognizing text of the disclosure, the initial feature enhancement coefficients of the feature values can be accurately and conveniently calculated according to the above expression.

In some embodiments of the disclosure, the coefficient updating unit is configured to calculate the feature enhancement coefficients of the plurality of feature values in the target feature unit respectively according to the following expression:

$${α}_{j} = exp ( {e}_{j} ) / {\sum }_{j = 1}^{j = n} exp ( {e}_{j} )$$

where eⱼ represents the initial feature enhancement coefficient of the j^{th} feature value in the target feature unit, α₁ represents the feature enhancement coefficient of the j^{th} feature value in the target feature unit, and n represents a number of the plurality of feature values in the target feature unit.

As seen above, according to the solution for recognizing text of the disclosure, the initial feature enhancement coefficients of the feature values in the target feature unit can be accurately obtained by updating the initial feature enhancement coefficients of the feature values in the target feature unit according to the above expression.

In some embodiments of the disclosure, the feature enhancement module 602 is configured to: perform the feature enhancement process on the plurality of feature values of the target feature unit respectively based on the plurality of feature values of the target feature unit and a global attention mechanism.

As seen above, according to the solution for recognizing text of the disclosure, the object of the global attention mechanism is the target feature unit, and the mechanism focuses on the key feature values of the target feature unit while considering all the feature values of the target feature unit, so that the feature enhancement process can focuses more on the feature values that are more representative of the image. Since the more representative feature values generally have a greater impact on the feature enhancement process, the feature enhancement process is performed on each feature value of the target feature unit using the global attention mechanism, which can improve the accuracy of the feature enhancement process, so that the representativeness of the first feature map after the feature enhancement process can be enhanced, and the text recognition performed on the image based on the more representative feature values can improve the accuracy of the text recognition.

In some embodiments of the disclosure, if the feature enhancement direction is the pixel column direction of the first feature map, the target feature unit is a column feature unit of the first feature map.

As seen above, according to the solution for recognizing text of the disclosure, in the case where the text in the image is curved in the pixel row direction, the features of such image in the pixel column direction are more representative. When the feature enhancement is performed on the first feature map, the feature enhancement is performed on each of the column feature units, which enhances the feature values in the pixel column direction in the first feature map. Therefore, after the feature enhancement is performed on the first feature map as described above, the accuracy of the text recognition can be improved when the text recognition is performed on the image with the curved text in the pixel column direction.

In some embodiments of the disclosure, if the feature enhancement direction is a pixel row direction of the first feature map, the target feature unit is a row feature unit of the first feature map.

As seen above, according to the solution for recognizing text of the disclosure, if the text in the image is curved in the pixel column direction, the features in the pixel row direction of the image are more representative. When the feature enhancement is performed on the first feature map, the feature enhancement is performed on each of the row feature units, which can enhance the feature values in the pixel row direction in the first feature map. Therefore, after the feature enhancement is performed on the first feature map as described above, the accuracy of the text recognition can be improved when the text recognition is performed on the image with the curved text in the pixel column direction.

In some embodiments of the disclosure, the feature map obtaining module 601 is configured to: obtain the first feature map with a number of pixel rows being a preset number of rows and a number of pixel columns being a target number of columns by performing a feature extraction process on the image, in which the preset number of rows is greater than 1, and the target number of columns is calculated based on a number of pixel columns of the image and the preset number of rows.

As seen above, according to the solution for recognizing text of the disclosure, the first feature maps obtained after the feature extraction is performed on the images of different sizes are under the same criterion, so that in the case where the above feature enhancement direction is the pixel column direction, the target feature units corresponding to different images all include the same number of feature values, which can improve the uniformity of the feature enhancement process for each feature value of the target feature unit, and improve the efficiency of the text recognition.

In addition, according to the solution of this embodiment, the number of pixel columns of the first feature map described above is the preset number of columns, and the number of pixel rows is to a number of rows calculated based on the number of pixel rows of the image and the preset number of columns, so that the uniformity of the feature enhancement process for each feature value in the target feature unit can also be improved in the case where the feature enhancement direction described above is the pixel row direction.

According to embodiments of the disclosure, the disclosure also provides an electronic device, a readable storage medium, and a computer program product.

According to embodiments of the disclosure, an electronic device is provided. The electronic device includes: at least one processor and a memory communicatively coupled to the at least one processor. The memory stores instructions executable by the at least one processor, and when the instructions are executed by the at least one processor, the at least one processor is caused to implement the method for recognizing text.

According to embodiments of the disclosure, a non-transitory computer-readable storage medium having computer instructions stored thereon is provided. The computer instructions are configured to cause a computer to implement the method for recognizing text.

According to embodiments of the disclosure, a computer program product including computer programs is provided. When the computer programs are executed by a processor, the method for recognizing text is implemented.

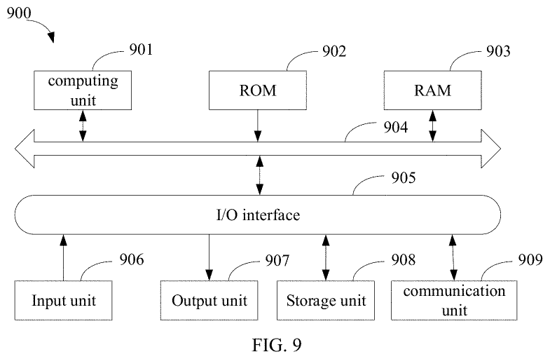

FIG. 9 is a block diagram of an example electronic device 900 according to embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 9, the electronic device 900 includes a computing unit 901 performing various appropriate actions and processes based on computer programs stored in a Read-Only Memory (ROM) 902 or computer programs loaded from the storage unit 908 to a Random Access Memory (RAM) 903. In the RAM 903, various programs and data required for the operation of the device 900 are stored. The computing unit 901, the ROM 902, and the RAM 903 are connected to each other through a bus 904. An Input/output (I/O) interface 905 is also connected to the bus 904.

Components in the device 900 are connected to the I/O interface 905, including: an input unit 906, such as a keyboard, a mouse; an output unit 907, such as various types of displays, speakers; a storage unit 908, such as a disk, an optical disk; and a communication unit 909, such as network cards, modems, and wireless communication transceivers. The communication unit 909 allows the device 900 to exchange information/data with other devices through a computer network such as the Internet and/or various telecommunication networks.

The computing unit 901 may be various general-purpose and/or dedicated processing components with processing and computing capabilities. Some examples of computing unit 901 include, but are not limited to, a Central Processing Unit (CPU), a Graphics Processing Unit (GPU), various dedicated AI computing chips, various computing units that run machine learning model algorithms, and a Digital Signal Processor (DSP), and any appropriate processor, controller and microcontroller. The computing unit 901 executes the various methods and processes described above, such as the method for recognizing text. For example, in some embodiments, the method for recognizing text may be implemented as a computer software program, which is tangibly contained in a machine-readable medium, such as the storage unit 908. In some embodiments, part or all of the computer program may be loaded and/or installed on the device 900 via the ROM 902 and/or the communication unit 909. When the computer program is loaded on the RAM 903 and executed by the computing unit 901, one or more steps of the method described above may be executed. Alternatively, in other embodiments, the computing unit 901 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Complex Programmable Logic Devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAM, ROM, Electrically Programmable Read-Only-Memory (EPROM), flash memory, fiber optics, Compact Disc Read-Only Memory (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: Local Area Network (LAN), Wide Area Network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, a server of distributed system or a server combined with block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for recognizing text, comprising:
obtaining a first feature map of an image;
for each target feature unit, performing a feature enhancement process on a plurality of feature values of the target feature unit respectively based on the plurality of feature values of the target feature unit, wherein the target feature unit is a feature unit in the first feature map along a feature enhancement direction; and
performing a text recognition process on the image based on the first feature map after the feature enhancement process.

2. The method of claim 1, wherein, for each target feature unit, performing the feature enhancement process on the plurality of feature values of the target feature unit respectively based on the plurality of feature values of the target feature unit, comprises:
calculating feature enhancement coefficients of the plurality of feature values of the target feature unit respectively based on the plurality of feature values of the target feature unit; and
performing the feature enhancement process on the plurality of feature values of the target feature unit respectively by performing a vector calculating on a coefficient vector of the target feature unit and a feature vector of the target feature unit, wherein the coefficient vector is a vector comprising weight coefficients of the plurality of feature values in the target feature unit along the feature enhancement direction, and the feature vector is a vector comprising the plurality of feature values in the target feature unit along the feature enhancement direction.

3. The method of claim 2, wherein calculating the feature enhancement coefficients of the plurality of feature values of the target feature unit respectively based on the plurality of feature values of the target feature unit, comprises:
calculating initial feature enhancement coefficients of the plurality of feature values in the target feature unit respectively based on a preset transformation coefficient and a preset transformation relation; and
obtaining the feature enhancement coefficients of the plurality of feature values of the target feature unit respectively by updating the initial feature enhancement coefficients of the plurality of feature values of the target feature unit based on the initial feature enhancement coefficients of the plurality of feature values of the target feature unit.

4. The method of claim 3, wherein calculating the initial feature enhancement coefficients of the plurality of feature values in the target feature unit based on the preset transformation coefficient and the preset transformation relation, comprises:
calculating the initial feature enhancement coefficients of the plurality of feature values in the target feature unit respectively according to the following expression:
e=W₁^{T} tan h(W₂h+b)
where e represents the initial feature enhancement coefficient, h represents the feature value, W₁ represents a first transformation parameter, W₁^{T} represents a transposition matrix of the first transformation parameter, W₂ represents a second transformation parameter, and b represents a third transformation parameter.

5. The method of claim 3, wherein obtaining the feature enhancement coefficients of the plurality of feature values of the target feature unit respectively by updating the initial feature enhancement coefficients of the plurality of feature values of the target feature unit based on the initial feature enhancement coefficients of the plurality of feature values of the target feature unit, comprises:
calculating the feature enhancement coefficients of the plurality of feature values in the target feature unit respectively according to the following expression:
$${α}_{j} = exp ( {e}_{j} ) / {\sum }_{j = 1}^{j = n} exp ( {e}_{j} )$$
where eⱼ represents the initial feature enhancement coefficient of the j^{th} feature value in the target feature unit, αⱼ represents the feature enhancement coefficient of the j^{th} feature value in the target feature unit, and n represents a number of the plurality of feature values in the target feature unit.

6. The method of claim 1, wherein, for each target feature unit, performing the feature enhancement process on the plurality of feature values of the target feature unit respectively based on the plurality of feature values of the target feature unit, comprises:
performing the feature enhancement process on the plurality of feature values of the target feature unit respectively based on the plurality of feature values of the target feature unit and a global attention mechanism.

7. The method of claim 1, wherein:
the target feature unit comprises a column feature unit of the first feature map in response to the feature enhancement direction being a pixel column direction of the first feature map; and
the target feature unit comprises a row feature unit of the first feature map in response to the feature enhancement direction being a pixel row direction of the first feature map.

8. The method of claim 1, wherein obtaining the first feature map of the image, comprises:
obtaining the first feature map with a number of pixel rows being a preset number of rows and a number of pixel columns being a target number of columns by performing a feature extraction process on the image, wherein the preset number of rows is greater than 1, and the target number of columns is calculated based on a number of pixel columns of the image and the preset number of rows.

9. An electronic device, comprising:
a processor; and
a memory communicatively coupled to the processor;
wherein the memory stores instructions executable by the processor, and when the instructions are executed by the processor, the processor is caused to:
obtain a first feature map of an image;
for each target feature unit, perform a feature enhancement process on a plurality of feature values of the target feature unit respectively based on the plurality of feature values of the target feature unit, wherein the target feature unit is a feature unit in the first feature map along a feature enhancement direction; and
perform a text recognition process on the image based on the first feature map after the feature enhancement process.

10. The device of claim 9, wherein when the instructions are executed by the processor, the processor is caused to:
calculate feature enhancement coefficients of the plurality of feature values of the target feature unit respectively based on the plurality of feature values of the target feature unit; and
perform the feature enhancement process on the plurality of feature values of the target feature unit respectively by performing a vector calculating on a coefficient vector of the target feature unit and a feature vector of the target feature unit, wherein the coefficient vector is a vector comprising weight coefficients of the plurality of feature values in the target feature unit along the feature enhancement direction, and the feature vector is a vector comprising the plurality of feature values in the target feature unit along the feature enhancement direction.

11. The device of claim 10, wherein when the instructions are executed by the processor, the processor is caused to:
calculate initial feature enhancement coefficients of the plurality of feature values in the target feature unit respectively based on a preset transformation coefficient and a preset transformation relation; and
obtain the feature enhancement coefficients of the plurality of feature values of the target feature unit respectively by updating the initial feature enhancement coefficients of the plurality of feature values of the target feature unit based on the initial feature enhancement coefficients of the plurality of feature values of the target feature unit.

12. The device of claim 11, wherein when the instructions are executed by the processor, the processor is caused to:
calculate the initial feature enhancement coefficients of the plurality of feature values in the target feature unit respectively according to the following expression:
e=W₁^{T} tan h(W₂h+b)
where e represents the initial feature enhancement coefficient, h represents the feature value, W₁ represents a first transformation parameter, W₁^{T} represents a transposition matrix of the first transformation parameter, W₂ represents a second transformation parameter, and b represents a third transformation parameter.

13. The device of claim 11, wherein when the instructions are executed by the processor, the processor is caused to:
calculate the feature enhancement coefficients of the plurality of feature values in the target feature unit respectively according to the following expression:
$${α}_{j} = exp ( {e}_{j} ) / {\sum }_{j = 1}^{j = n} exp ( {e}_{j} )$$
where eⱼ represents the initial feature enhancement coefficient of the j^{th} feature value in the target feature unit, αⱼ represents the feature enhancement coefficient of the j^{th} feature value in the target feature unit, and n represents a number of the plurality of feature values in the target feature unit.

14. The device of claim 9, wherein when the instructions are executed by the processor, the processor is caused to:
perform the feature enhancement process on the plurality of feature values of the target feature unit respectively based on the plurality of feature values of the target feature unit and a global attention mechanism.

15. The device of claim 9, wherein:
the target feature unit comprises a column feature unit of the first feature map in response to the feature enhancement direction being a pixel column direction of the first feature map; and
the target feature unit comprises a row feature unit of the first feature map in response to the feature enhancement direction being a pixel row direction of the first feature map.

16. The device of claim 9, wherein when the instructions are executed by the processor, the processor is caused to:
obtain the first feature map with a number of pixel rows being a preset number of rows and a number of pixel columns being a target number of columns by performing a feature extraction process on the image, wherein the preset number of rows is greater than 1, and the target number of columns is calculated based on a number of pixel columns of the image and the preset number of rows.

17. A non-transitory computer-readable storage medium having computer instructions stored thereon, wherein the computer instructions are configured to cause a computer to implement a method for recognizing text, the method comprising:
obtaining a first feature map of an image;
for each target feature unit, performing a feature enhancement process on a plurality of feature values of the target feature unit respectively based on the plurality of feature values of the target feature unit, wherein the target feature unit is a feature unit in the first feature map along a feature enhancement direction; and
performing a text recognition process on the image based on the first feature map after the feature enhancement process.

18. The non-transitory computer-readable storage medium of claim 17, wherein, for each target feature unit, performing the feature enhancement process on the plurality of feature values of the target feature unit respectively based on the plurality of feature values of the target feature unit, comprises:
calculating feature enhancement coefficients of the plurality of feature values of the target feature unit respectively based on the plurality of feature values of the target feature unit; and
performing the feature enhancement process on the plurality of feature values of the target feature unit respectively by performing a vector calculating on a coefficient vector of the target feature unit and a feature vector of the target feature unit, wherein the coefficient vector is a vector comprising weight coefficients of the plurality of feature values in the target feature unit along the feature enhancement direction, and the feature vector is a vector comprising the plurality of feature values in the target feature unit along the feature enhancement direction.

19. The non-transitory computer-readable storage medium of claim 18, wherein calculating the feature enhancement coefficients of the plurality of feature values of the target feature unit respectively based on the plurality of feature values of the target feature unit, comprises:
calculating initial feature enhancement coefficients of the plurality of feature values in the target feature unit respectively based on a preset transformation coefficient and a preset transformation relation; and
obtaining the feature enhancement coefficients of the plurality of feature values of the target feature unit respectively by updating the initial feature enhancement coefficients of the plurality of feature values of the target feature unit based on the initial feature enhancement coefficients of the plurality of feature values of the target feature unit.

20. The non-transitory computer-readable storage medium of claim 19, wherein calculating the initial feature enhancement coefficients of the plurality of feature values in the target feature unit based on the preset transformation coefficient and the preset transformation relation, comprises:
calculating the initial feature enhancement coefficients of the plurality of feature values in the target feature unit respectively according to the following expression:
e=W₁^{T} tan h(W₂h+b)
where e represents the initial feature enhancement coefficient, h represents the feature value, W₁ represents a first transformation parameter, W₁^{T} represents a transposition matrix of the first transformation parameter, W₂ represents a second transformation parameter, and b represents a third transformation parameter; or
wherein obtaining the feature enhancement coefficients of the plurality of feature values of the target feature unit respectively by updating the initial feature enhancement coefficients of the plurality of feature values of the target feature unit based on the initial feature enhancement coefficients of the plurality of feature values of the target feature unit, comprises:
calculating the feature enhancement coefficients of the plurality of feature values in the target feature unit respectively according to the following expression:
$${α}_{j} = exp ( {e}_{j} ) / {\sum }_{j = 1}^{j = n} exp ( {e}_{j} )$$
where eⱼ represents the initial feature enhancement coefficient of the j^{th} feature value in the target feature unit, αⱼ represents the feature enhancement coefficient of the j^{th} feature value in the target feature unit, and n represents a number of the plurality of feature values in the target feature unit.
